(19) United States
(12) Patent Application Publication
(10) Pub. No.: US 2013/0277399 A1
(43) Pub. Date: Oct. 24, 2013

(54) METHOD FOR OPERATING A CELLULAR WHEEL SLUICE AND CELLULAR WHEEL SLUICE FOR CARRYING OUT THE METHOD

(71) Applicant: COPERION GMBH, Stuttgart (DE)

(72) Inventors: Bruno ZINSER, Waldburg (DE); Reinhard ERNST, Weingarten (DE); Frank SPECK, Weingarten (DE); Martin STEPHAN, Bergatreute (DE)

(21) Appl. No.: 13/867,650

(22) Filed: Apr. 22, 2013

(30) Foreign Application Priority Data
Apr. 20, 2012 (DE) 10 2012 206 590.3

(51) Int. Cl. G01F 11/10

(52) U.S. Cl. CPC B65G 53/4633
USPC 222/368

(57) ABSTRACT

A cellular wheel sluice has a housing, a feed shaft opening therein and an outlet shaft opening out therefrom. Arranged between the shafts is a cellular wheel. The latter is arranged so as to be rotatably drivable about a horizontal rotational axis in a cylindrical cellular wheel housing portion. A cellular wheel drive shaft non-rotatably connected to the cellular wheel is rotatably mounted in the housing. A pressure drop is applied during operation of the cellular wheel sluice, a higher pressure being present in the feed shaft than in the outlet shaft. The cellular wheel is operated during the product conveyance between the feed shaft and the outlet shaft at a rotational speed in such a way that an outer periphery of the cellular wheel reaches a speed that is greater than 0.6 m/s.

### CROSS-REFERENCES TO RELATED APPLICATIONS

This application claims the priority of German Patent Application, Serial No. 10 2012 206 590.3, filed Apr. 20, 2012, pursuant to 35 U.S.C. 119(a)-(d), the content of which is incorporated herein by reference in its entirety as if fully set forth herein.

### FIELD OF THE INVENTION

The invention relates to a method for operating a cellular wheel sluice. Furthermore, the invention relates to a cellular wheel sluice for carrying out the method.

### BACKGROUND OF THE INVENTION

Cellular wheel sluices also known as rotary feeders or rotary valves in various configurations are known from the prior art, for example from DE 40 38 237 A1, DE 298 19 748 U1, EP 0 082 947 A1, DE 34 32 316 A1, DE 198 04 431 A1 and EP 1 879 827 A2.

### SUMMARY OF THE INVENTION

An object of the present invention is to develop an operating method for a cellular wheel sluice in such a way that at a given dimensioning of the cellular wheel sluice, its throughput is increased, or in that a predetermined throughput can be achieved with a cellular wheel sluice that is smaller in dimension.

This object is achieved according to the invention by an operating method having the method steps:
applying a pressure drop, a higher pressure being present in the feed shaft than in the outlet shaft,
operating the cellular wheel during the product conveyance between the feed shaft and the outlet shaft at a rotational speed such that an outer periphery of the cellular wheel reaches a speed, which is greater than 0.6 m/s.

Tests have shown that by applying a pressure drop from top to bottom and operating the cellular wheel sluice at a higher peripheral speed, the rotational speed, at which a throughput maximum of the cellular wheel sluice is achieved at otherwise given boundary conditions, is significantly increased in comparison to an operation without a pressure drop or an operation with a reversed pressure drop. An increase in the peripheral speed in these pressure conditions therefore does not lead, and this is very surprising, to a reduction in the throughput, but to a throughput increase. A limit peripheral speed at given pressure and dimension ratios of a specific cellular wheel, depending on the pressure drop between the feed shaft and the outlet shaft, leads to greater peripheral speeds. As extensive test series of the Applicant have shown, the output, which is thus pressure-assisted, from the cellular wheel sluice leads to a displacement of a throughput maximum or an output maximum toward higher rotational speeds. The speed of the outer periphery of the cellular wheel, in other words the product of the cellular wheel outer periphery and the rotational speed, may be greater than 0.62 m/s, may be greater than 0.65 m/s, may be greater than 0.7 m/s, may be greater than 0.8 m/s, may be greater than 0.9 m/s, may be greater than 1.0 m/s, may be greater than 1.1 m/s, may be greater than 1.2 m/s, may be greater than 1.3 m/s, may be greater than 1.5 m/s or may even be greater still and. for example, be 1.8 m/s or 2.0 m/s. This speed is also called the tangential speed. The pressure difference between the feed shaft and the outlet shaft may be in the region of 1 bar and may alternatively, to apply an excess pressure to the feed shaft, also be achieved, for example, in that a negative pressure is applied to the outlet shaft. The pressure difference may be 1 bar, but may also be greater than 1 bar, which is achieved by applying an excess pressure at least at the feed shaft. The pressure drop may be 2 bar, may be greater than 2 bar, may be 3 bar, may be greater than 3 bar, may be 4 bar, may be greater than 4 bar, may be 5 bar, or may be still greater than 5 bar. Such modes of operation may be present in reactor output sluices and, for example, in typical applications, such as an output from pressure-loaded fluidized bed dryers, pressure rotary filters or pressure filters, as used, for example, in a PTA wet cake process. The advantages of a cellular wheel sluice of this type come to the fore, in particular, for example, in conjunction with a PTA wet cake process, in other words in a method for producing terephthalic acid (PTA), which is described, for example, in WO 00/71226 A1 or JP 11 179 115 A. A corresponding operating method can also be used in the output in lignite drying and in the output of beet pulp from a fluidized bed dryer or in the output of mineral substances from pressure filters. Because of the pressure drop, the advantage is also produced that in a cellular wheel sluice operated in this manner, products can also be conveyed which are poorly or scarcely free-flowing, for example slurry-like or highly viscous and sticky products.

The advantages of a cellular wheel sluice for carrying out the method according to the invention, wherein when applying the pressure drop in the feed shaft, a pressure is applied, which is higher than normal pressure, correspond to those which have already been described above with reference to the operating method. The cellular wheel sluice is rotatable about a horizontal axis and thus, in the assembled state, has a drive shaft, which runs horizontally.

Parameter conditions comprising a ratio of:
a minimum feed diameter at the transition of the feed shaft to the cellular wheel housing portion and
a cellular wheel diameter
   in a range between 0.7 and 1.3, and comprising a ratio of the minimum feed diameter and the cellular wheel diameter in the range between 0.8 and 1.2, and comprising a ratio of
a diameter of the cellular wheel drive shaft in the region of a transition of a base body of the cellular wheel into the cellular wheel drive shaft and
a cellular wheel diameter
   of at least 0.2, and comprising a ratio of
a diameter of an inner cell limitation on the drive shaft side and
a cellular wheel diameter
in a range between 0.3 and 0.8,
   have proven to be particularly suitable to optimize the throughput. The ratio between the minimum feed diameter and the cellular wheel diameter may be in the range between 0.9 and 1.1 and may, in particular, be in the region of 1.0. Ratios D/C according to the invention have proven to be particularly suitable to ensure adequate stability of the cellular wheel sluice operated from top to bottom with the pressure drop. For cellular wheel diameters in the range between 150 mm and 400 mm, a ratio D/C of at least 0.25 may be used. For cellular wheels with a diameter between 400 mm and 800 mm, a ratio D/C of at least 0.2 may be used. The lower limit of the ratio D/C may also be higher, for example 0.3, 0.35, 0.4, 0.45, 0.5 or even higher.

Cellular wheel variants comprising laterally open intermediate spaces between the cellular wheel vanes, and cellular wheel side discs, which cover at least a portion of a cellular wheel cross section and are non-rotatably connected to the cellular wheel vanes, are particularly suitable depending on the area of use and the environmental requirements. Side disc-free cellular wheels, which are also called open cellular wheels, can be used, in particular, for powder conveyance. Cellular wheels with side discs, which can laterally cover a part or the entire diameter of the cellular wheel, can be used, in particular, when conveying wear-intensive products.

An eccentricity, in which a longitudinal axis of the cellular wheel drive shaft does not coincide with a cylinder axis of the cellular wheel housing portion, allows a compensation of forces weighing on the cellular wheel during operation. This applies, in particular, to an eccentricity, in which the longitudinal axis is displaced toward the feed shaft relative to the cylinder axis. The eccentricity may be in the range between 10 μm and 500 μm and may, for example, be 20 μm, 50 μm, 100 μm, or 200 μm.

A ratio D_{eff}/C of a diameter of an inner cell limitation on the drive shaft side and a cellular wheel diameter in a range between 0.3 and 0.8 has proven to be particularly suitable for conveying specific conveyed media. The ratio D_{eff}/C may be in the range between 0.4 and 0.7 and may be in the range between 0.5 and 0.6. Cellular wheels of this type, which are also called compartmentalized cellular wheels, can be used, in particular, in the case of moist, slurry-like, highly viscous or sticky products. In the case of such products, it is also advisable to configure the cells with faces that are as large as possible and free of hindrances. The chambers may then be smooth-walled and without projecting assembly components toward the shaft axis, in other words optionally in the direction of the compartmentalized area, and in the region of the cellular wheel vanes.

An embodiment of the invention will be shown in more detail below with the aid of the drawings

### BRIEF DESCRIPTION OF THE DRAWINGS

FIG. 1 schematically shows a side view of a cellular wheel sluice, cut in half in an axial longitudinal section;

FIG. 2 shows a section along the line II-II in FIG. 1;

FIG. 3 shows a detailed enlargement from the detail III in FIG. 1; and

FIG. 4 shows a further configuration of a cellular wheel sluice in a sectional view similar to FIG. 2 perpendicular to a cellular wheel drive shaft.

### DESCRIPTION OF THE PREFERRED EMBODIMENT

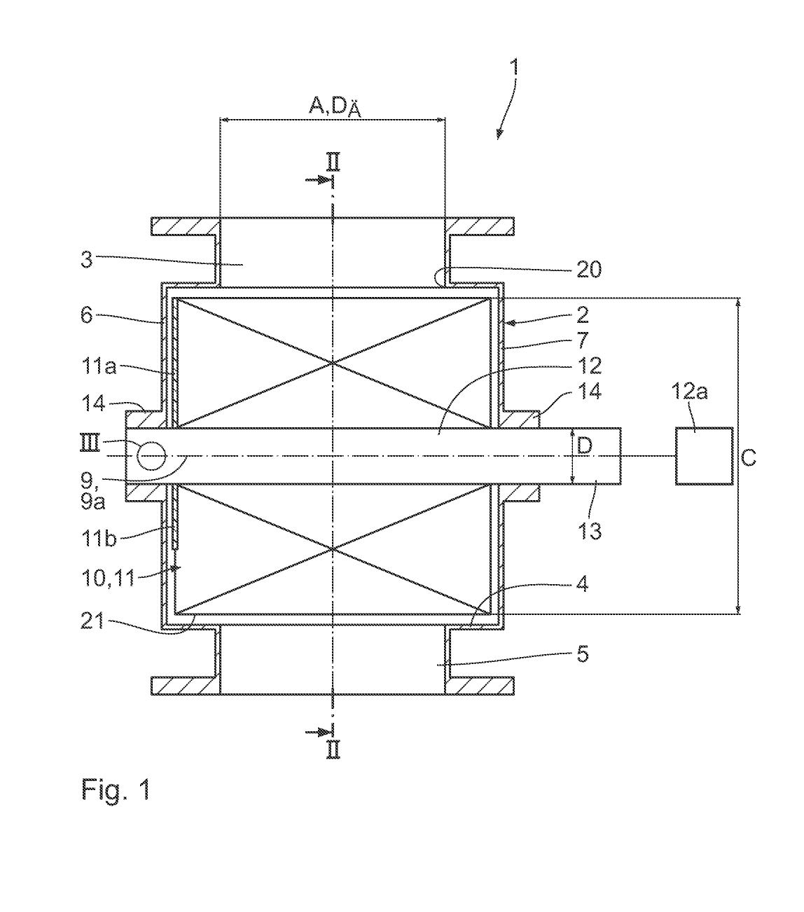

A cellular wheel sluice 1 has a housing 2, which is upwardly limited in FIG. 1 by a feed shaft 3, which opens into a cellular wheel housing bore 4. The housing 2 is downwardly limited in FIG. 1 by an outlet shaft 5, which opens out of the cellular wheel housing bore 4. Toward both sides in FIG. 1, the housing 2 is limited by housing side covers 6, 7. To the front and rear in FIG. 1, the housing 2 is limited by further housing walls, which are not visible in FIG. 1.

The cellular wheel housing bore 4 has the form of a hollow cylinder lying transversely in FIG. 1, with a cylinder axis 9. A cellular wheel 10 is arranged to be rotatably drivable in the cellular wheel housing bore 4 about a longitudinal axis 9a adjacent to the cylinder axis 9. The housing bore 4 is a cylindrical cellular wheel housing portion of the housing 2.

The cellular wheel 10 is side disc-free. The sector-shaped cellular wheel chambers separated from one another by cellular wheel webs or cellular wheel vanes 11 in the peripheral direction about the longitudinal axis 9, in other words the cells, are laterally limited by the housing side covers 6, 7 and the cellular wheel 10 has laterally open cellular wheel chambers between the cellular wheel webs 11. The housing side covers 6, 7 are therefore end face limitations of the cellular wheel housing bore 4.

In an alternative configuration, not shown, of the cellular wheel sluice 1, which is indicated in FIG. 1 in the region of a left-hand end face of the cellular wheel vanes 11, adjacent to the housing side covers 6, 7, the cellular wheel has cellular wheel side discs 11a, which cover at least a portion of a cross section of the cellular wheel 10 and are non-rotatably connected to the cellular wheel webs 11. The cellular wheel side discs, in this alternative embodiment, can cover, from the inside, in other words, from the rotational axis 9a, a part of the cellular wheel cross section, for example a quarter, a third, a half (cf. side disc variant 11b, also indicated in FIG. 1), two thirds or three quarters of the cellular wheel cross section or can also cover the entire cellular wheel cross section. If cellular wheel side discs 11a, 11b are present, these are, optionally together with the housing side covers 6, 7, the end face limitations of the cells.

The cellular wheel housing bore 4 forms an interior of the cellular wheel sluice 1, through which conveyed product is conveyed from the feed shaft 3 to the outlet shaft 5 by means of rotation of the cellular wheel 10.

The cellular wheel 10 is non-rotatably or torque proof connected to a cellular wheel drive shaft 12, which is driven by a drive motor 12a. A shaft stub 13, which axially continues the cellular wheel drive shaft 12 and is therefore part of the drive shaft, of the cellular wheel 10 is mounted in a shaft receiver or a shaft bearing 14 by means of an axial/radial bearing. The shaft can also be repeatedly stepped in terms of its diameter, between the drive shaft 12 at the axial height of the cellular wheel vanes 11 and the shaft stubs 13 on both sides. Between the axial/radial bearing and the cellular wheel housing bore 4, the cellular wheel drive shaft 12, 13 is sealed against the housing side cover 7 by means of a seal assembly, which comprises a seal and a flushing gas line, which is not shown in more detail in the schematic FIG. 1. The seal assembly is arranged between an outer casing wall of the drive shaft 12, 13 and an inner wall surrounding it of the side cover 7 and seals these two walls with respect to one another.

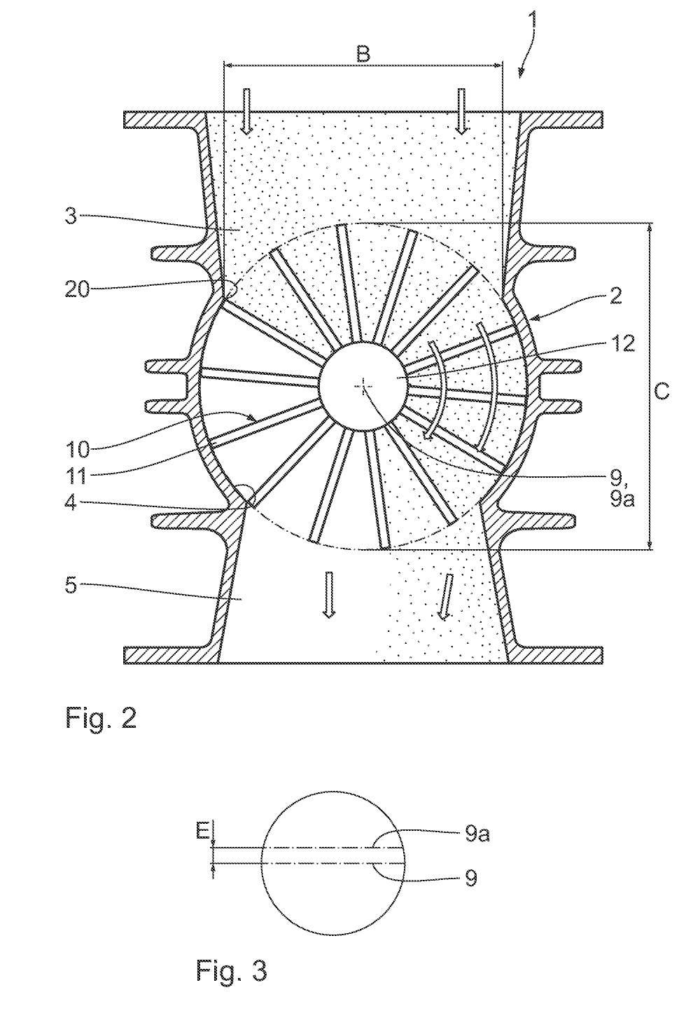

At the transition of the feed shaft 3 to the housing bore 4, in other words to the cellular wheel housing portion, the housing 2 has cellular wheel feed cross section 20, which is rectangular, projected onto a plane and, parallel to the cylinder axis 9, has a cross sectional dimension A and a cross sectional dimension B perpendicular to this cross sectional dimension A (cf. FIG. 2). In the region of the flange on the feed side, the feed shaft 3 has a housing inlet cross section. Depending on the forming of the feed shaft 3, either this housing inlet cross section or the cellular wheel feed cross section 20 is cross section-limiting. The smallest cross section of the feed shaft 3 will be called the minimum feed cross section below. This minimum feed cross section has a circular minimum feed cross section equivalent with a diameter D_{Ä}. The area of the minimum feed cross section if the inlet into the housing bore 4 is cross section-limiting is A×B. If the diameter on the feed shaft side, in other words the upper housing inlet, is limiting for the inlet cross section, the area of the minimum feed cross section is determined by this inlet diameter. Even if the area A×B is determining for the minimum feed cross section, the equivalent diameter of this area can be given that corresponds to the diameter of a round feed shaft. There applies to this minimum feed diameter D_{Ä} called the equivalent diameter:

$${D}_{\ddot{A}} = \sqrt{\frac{4 AB}{π}}$$

A diameter of the cellular wheel 10 has the value C. The ratio of the minimum feed diameter and the cellular wheel diameter, D_{Ä}/C, is in the range between 0.7 and 1.3.

The ratio between the diameter D (cf. FIG. 2) of the drive shaft 12 in the region of the shaft receiver 14 and the cellular wheel diameter C, D/C, inter alia also depending on the cellular wheel diameter, is at least 0.2. For larger cellular wheel diameters, for example of 400 mm and greater, the value D/C is at least 0.2. For smaller cellular wheel diameters, the lower limit may be slightly higher, for example 0.25. Larger values of the ratio D/C are also possible, for example 0.3, 0.35, 0.4, 0.45, 0.5 or else still higher values, which in an extreme case can even go to a value of 0.9.

The diameter of the shaft in a central cellular wheel body portion, where the shaft 12 passes through the housing 2, may differ from the diameter in the region of shaft end portions or shaft stubs. This diameter of the shaft 12 between the end portions may, in particular step-wise, be greater than a diameter D at the transition to the cellular wheel body shaft portion. The shaft diameter D, where maximum torques act on the shaft 12, is to be used there for the above parameter ratio D/C. This is generally the case at the transition of the shaft 12 into the cellular wheel body.

The longitudinal axis 9a of the cellular wheel drive shaft 12, in other words the rotational axis, about which the cellular wheel 10 rotates, does not coincide with the cylinder axis 9 of the cellular wheel housing portion 4. The detailed enlargement according to FIG. 3 discloses that these two axes 9a and 9 run parallel to one another and have a spacing E with respect to one another, in other words an eccentricity with respect to one another. The eccentricity E is in a range between 10 μm and 1 mm, in particular in the range between 50 μm and 200 μm, for example in the range from 100 μm or 200 μm.

The eccentricity E is thus such that the rotational axis is displaced toward the feed shaft 3 relative to the cylinder axis 9.

During operation of the cellular wheel sluice 1, a pressure drop is firstly applied, a higher pressure being present in the feed shaft 3 than in the outlet shaft 5. The pressure difference may be in the region of 1 bar, may be greater than 1 bar, may be greater than 2 bar, may be greater than 3 bar, may be greater than 4 bar, may be 5 bar, may be greater than 5 bar, may be greater than 6 bar or may even be still greater. For example, the feed shaft 3 may be placed under a pressure of 5 bar, while the outlet shaft 5 is operated at normal pressure, so a pressure difference of 4 bar is present between the feed shaft 3 and the outlet shaft 5. The outlet shaft 5 may also be placed under negative pressure, the feed shaft 3 then being able to be operated under normal pressure conditions, so a pressure difference of less than 1 bar is present.

The product is then conveyed by the cellular wheel sluice 1, in particular bulk goods in the form of a granulate or a powder or another free-flowing product. Even poorly free-flowing products, in particular moist, slurry-like, highly viscous or sticky products, can be conveyed by the cellular wheel sluice 1 operated in this manner. During the product conveyance between the feed shaft 3 and the outlet shaft 5, the cellular wheel 10 is operated at a rotational speed in such a way that an outer periphery of the cellular wheel, in other words radial outer edges 21 of the cellular wheel webs 11, reaches a speed, which is greater than 0.6 m/s. This speed may be greater than 0.8 m/s, may be greater than 1.0 m/s, may be greater than 1.5 m/s or may even be still greater.

The pressure difference between the feed shaft 3 and the outlet shaft 5, together with the gravitational force, assists the conveyance of the product by the cellular wheel 10. The output of the product from the respective opening cellular wheel chamber into the outlet shaft 5, assuming a corresponding seal of the cellular wheel webs 11 against the housing 2, takes place at a substantially abrupt pressure relief, the product present in this chamber being ejected into the outlet shaft 5. The entry of the product from the feed shaft 3 into the opening cellular wheel chamber is also assisted by the pressure difference, as the product is pressed into the opening cellular wheel chamber.

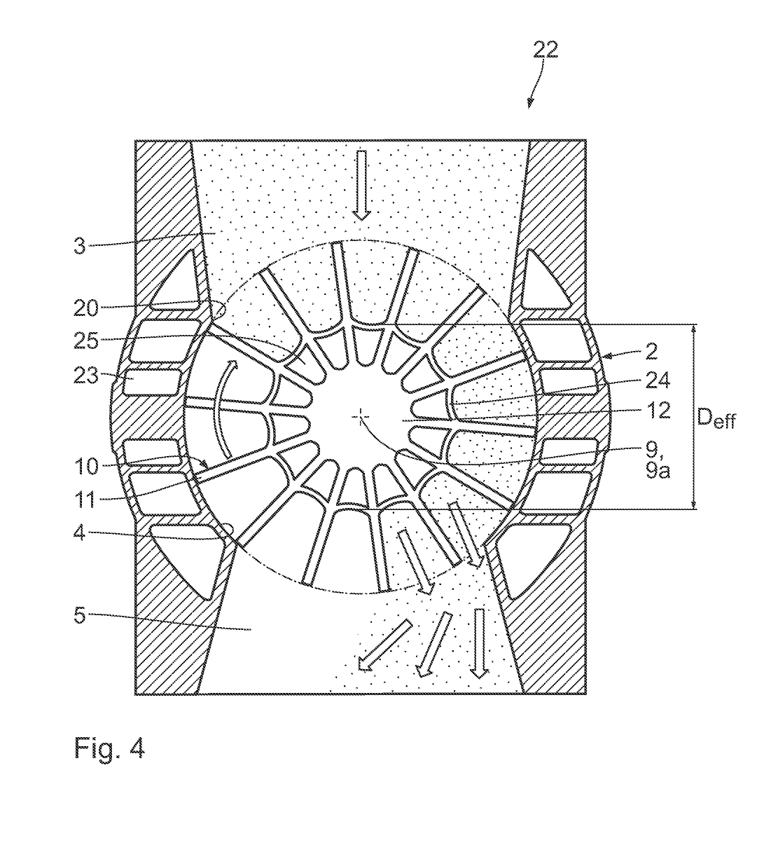

In a view similar to FIG. 2, FIG. 4 shows a similar configuration of a cellular wheel sluice 22. Components corresponding to those which have already been described above with reference to the cellular wheel sluice 1 according to FIGS. 1 to 3 have the same reference numerals and will not be discussed again in detail.

The housing 2 of the cellular wheel sluice 22, in housing walls, which limit the housing bore 4, has channels 23, which can be used to guide a heat transfer medium to control the temperature of the housing 2.

In the cellular wheel sluice 22, an effective diameter D_{eff} of the cellular wheel drive shaft 12 is enlarged by additional cell walls 24 on the shaft side, which are partition wall limitations of the cells. Sector-like cavities 25, which do not contribute to the product conveyance, remain between the cell walls 24 and the actual cellular wheel drive shaft 12. The ratio D_{eff}/C may be in the range between 0.3 and 0.8, between 0.4 and 0.7 and between 0.5 and 0.6.

What is claimed is:

1. A method for operating a cellular wheel sluice (1; 22), wherein the cellular wheel sluice (1; 22) has:
a housing (2)
with a feed shaft (3) opening from above into the housing (2),
with an outlet shaft (5) opening downwardly out of the housing (2),
a cellular wheel (10), which is arranged between the feed shaft (3) and the outlet shaft (5) and is arranged to be rotationally drivable about a horizontal rotational axis (9a) in a cylindrical cellular wheel housing portion (4) of the housing (2),
a cellular wheel drive shaft (12), which is non-rotatably connected to the cellular wheel (10) and is rotatably mounted in the housing (2),
comprising the following steps:
applying a pressure drop, a higher pressure being present in the feed shaft (3) than in the outlet shaft (5),
operating the cellular wheel (10) during the product conveyance between the feed shaft (3) and the outlet shaft (5) at a rotational speed such that an outer periphery of the cellular wheel (10) reaches a speed, which is greater than 0.6 m/s.

2. A method according to claim 1, wherein when applying the pressure drop in the feed shaft, a pressure is applied, which is higher than normal pressure.

3. A cellular wheel sluice for carrying out the method for operating a cellular wheel sluice (1; 22), wherein the cellular wheel sluice (1; 22) has:
a housing (2)
with a feed shaft (3) opening from above into the housing (2),
with an outlet shaft (5) opening downwardly out of the housing (2),
a cellular wheel (10), which is arranged between the feed shaft (3) and the outlet shaft (5) and is arranged to be rotationally drivable about a horizontal rotational axis (9a) in a cylindrical cellular wheel housing portion (4) of the housing (2),
a cellular wheel drive shaft (12), which is non-rotatably connected to the cellular wheel (10) and is rotatably mounted in the housing (2),
comprising the following steps:
applying a pressure drop, a higher pressure being present in the feed shaft (3) than in the outlet shaft (5),
operating the cellular wheel (10) during the product conveyance between the feed shaft (3) and the outlet shaft (5) at a rotational speed such that an outer periphery of the cellular wheel (10) reaches a speed, which is greater than 0.6 m/s
wherein when applying the pressure drop in the feed shaft, a pressure is applied, which is higher than normal pressure.

4. A cellular wheel sluice according to claim 3, comprising a ratio (D_{Ä}/C) of:
a minimum feed diameter (D_{Ä}) at the transition of the feed shaft (3) to the cellular wheel housing portion (4) and
a cellular wheel diameter (C)
in a range between 0.7 and 1.3.

5. A cellular wheel sluice according to claim 4, comprising a ratio of the minimum feed diameter (D_{Ä}) and the cellular wheel diameter (C) in the range between 0.8 and 1.2.

6. A cellular wheel sluice according to claim 3, comprising a ratio (D/C) of
a diameter (D) of the cellular wheel drive shaft (12) in the region of a transition of a base body of the cellular wheel (10) into the cellular wheel drive shaft (12) and
a cellular wheel diameter (C)
of at least 0.2.

7. A cellular wheel sluice according to claim 3, comprising laterally open intermediate spaces between the cellular wheel vanes (11).

8. A cellular wheel sluice according to claim 3, comprising cellular wheel side discs (11a, 11b), which cover at least a portion of a cellular wheel cross section and are non-rotatably connected to the cellular wheel vanes (11).

9. A cellular wheel sluice according to claim 3, wherein a longitudinal axis (9a) of the cellular wheel drive shaft (12) does not coincide with a cylinder axis (9) of the cellular wheel housing portion (4).

10. A cellular wheel sluice according to claim 9, wherein the longitudinal axis (9a) is displaced toward the feed shaft (3) relative to the cylinder axis (9).

11. A cellular wheel sluice according to claim 3, comprising a ratio of
a diameter (D_{eff}) of an inner cell limitation (24) on the drive shaft side and
a cellular wheel diameter (C)
in a range between 0.3 and 0.8.
